(19) United States
(12) Patent Application Publication
(10) Pub. No.: US 2006/0106632 A1
(43) Pub. Date: May 18, 2006

(54) Method and system for financing home ownership

(76) Inventor: Michael L. Stark, New Windsor, NY (US)

Correspondence Address: STEVEN HOROWITZ, ESQ., 295 MADISON AVE, SUITE 700, NEW YORK, NY, 10017, US

(21) Appl. No.: 10/992,179

(22) Filed: Nov. 17, 2004

(51) Int. Cl. G06Q 99/00

(52) U.S. Cl. 705/1

(57) ABSTRACT

A method and system of financing real estate ownership involving forming a title holder entity to own equity in each property, forming a pooling entity to own most of the title holding entity, the pooling entity owned by the general public directly or through equity pools, screening applicants to determine financial suitability, the title holder selling shares of a class of stock unique to a particular applicant for each property, the particular applicant having sole use and enjoyment of the property and being an owner/occupant, the sale price between 1% and 5% of market value plus underwriting fees, each applicant paying rent to the title holder entity in exchange for additional shares, the title holder entity issuing cash dividends to the general public in an amount of the rent less management fees. Each applicant's shares are held by the title holder entity as rent security.

### FIELD OF THE INVENTION

The field of this invention is investment vehicles, and more particularly, methods and systems for financing home ownership.

### BACKGROUND OF THE INVENTION AND DISCUSSION OF THE PRIOR ART

Many potential homeowners or those relocating from one home to another have difficulty obtaining affordable long-term home financing because of either sub-par credit ratings or the lack of a credit history. Furthermore, given recent increases in real estate values, many individuals cannot afford a minimum down payment of 20% that most banks require for conventional financing. If an individual can afford a 5% down payment, he/she is usually penalized by having to pay for private mortgage insurance and higher interest rates or bears the long-term risk of higher interest rates on an adjustable rate mortgage.

The present invention is also designed to overcome disadvantages of investments of the prior art. For instance, on the one hand, people can currently invest their money in bonds guaranteed by the Government National Mortgage Association (“GNMA”). The bonds, known as “Ginnie Maes”, pay a steady stream of principal and interest payments that represent pools of mortgages sold by originating banks on the secondary market, and do not entail any significant default risk because GNMA, an agency of the United States government, guarantees these monthly payments.

The general risks associated with GNMA's relate to moves in long-term interest rates and an investors time horizon. When market rates are falling, bonds generally rise in market value to compensate investors for the loss of future interest earned via current capital gains. However, capital gains may not be realized to a certain extent because of the risk that many mortgages will be prepaid when homeowners refinance. Homeowners refinance their fixed rate mortgages to lock in a reduction of their monthly interest and principal payments.

Alternatively, when market rates are rising, bonds generally fall in market value because a purchasing investor requires additional compensation from a selling investor to account for the difference between the new and higher market rate of interest and the lower rate of interest being paid on bonds previously issued.

### SUMMARY OF THE PRESENT INVENTION

The present invention is a method and system of financing residential real estate ownership without incurring significant transaction costs. It features numerous other advantages as well. The method and system involve forming a title holder entity to own equity in each property, forming a pooling entity to own most of the title holding entity, the pooling entity owned by the general public, screening applicants to determine financial suitability, the title holder selling shares of a class of stock unique to a particular applicant for each property. The particular applicant has sole use and enjoyment of the property and becomes an owner/occupant. The sale price is typically between approximately 1% and approximately 5% of the property's market value plus underwriting fees. Each applicant also pays rent to the title holder entity in exchange for additional shares, the title holder entity issuing cash dividends to the general public in an amount of the rent less management fees. A plurality of equity pools owned by the general public are formed to own the pooling entity. Each applicant's shares are held by the title holder entity as rent security.

### IMPORTANT OBJECTS AND ADVANTAGES

The following important objects and advantages of the present invention are:

(1) to provide a method and system for financing individual residential real estate ownership while avoiding the typical transaction costs such as real estate broker commissions, mortgage recording tax, and legal fees each time rights to a home participating in the program are sold;

(2) to provide a method and system under which someone unable to come up with a down payment for a home can still buy the home;

(3) to provide a method and system for financing home ownership that has tax advantages over the methods of the prior art;

(4) to provide a method and system in which potential homeowners who have difficulty obtaining affordable long-term home financing because of a poor credit rating or the lack of a credit history can still affordably finance the purchase of a home;

(5) to provide such a method and system that can be applied to a virtually unlimited number of potential homeowners across the country;

(6) to provide a method and system for financing home ownership that invokes processing conducted by fewer institutional bureaucracies than those involved in traditional home financing;

(7) to provide a method and system for financing home ownership that is akin to an initial public offering for a corporation;

(8) to provide such a method and system that requires the applicant applying to be an owner/occupant to only raise the money representing as little as one percent of the cost of the residential property plus underwriting fees;

(9) to provide a method and system for home financing that allows an owner-occupant to sell his or her homeownership rights when moving without having to sell the entire home;

(10) to provide a method and system for financing home ownership that affords an investment vehicle to the general public;

(11) to provide such a method and system wherein the investment vehicle offers greater economic advantages to the public than investing in GNMA's would offer;

(12) to provide a method and system for financing home ownership that offers an investment that has the opportunity for long term capital gain to the owner/occupants;

(13) to provide a method and system for financing home ownership that avoids the legal liabilities associated with traditional home ownership when legal title is in the name of the owner/occupant;

(14) to provide a system and method of affording individuals the ability to control ownership of a residential real estate property with as little as 1% or less of the ownership of the home;

(15) to provide a system and method whereby individuals can raise funds to accomplish the said control over the residential real estate property with as little as less than 1% to approximately 5% of the property's ownership; and

(16) to provide a method and system wherein individuals can control and manipulate their debt-to-equity ratios as financial conditions change.

### BRIEF DESCRIPTION OF THE DRAWINGS

FIG. 1 is a chart showing the elements of the system and method of the present invention.

### DETAILED DESCRIPTION OF THE PREFERRED EMBODIMENT

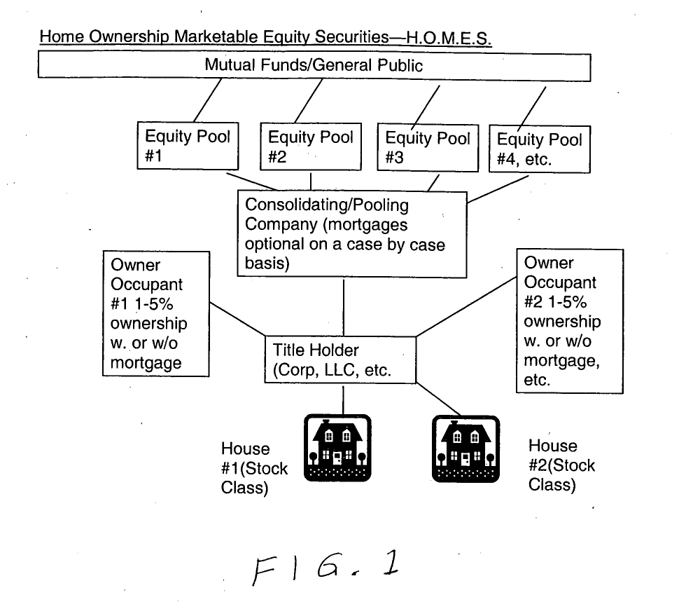

The method and system of the present invention will now be illustrated including by reference to the accompanying drawing. In FIG. 1, the system of the present invention has been assigned reference numeral 10. Other elements have been assigned the reference numerals referred to below.

The method and system of the present invention includes a publicly-traded stock representing shares of ownership in pools of single and multiple-family homes. The invention combines the rationale of different legal and investment strategies from the vantage point of the average investor, homeowner, and consumer.

How the Method and System Works

In accordance with the method and system of the present invention a corporation or other limited liability entity is formed, probably by an underwriting investment bank (“underwriter”) to purchase and take title to all real estate participating in the program. The underwriter charges underwriting fees for its services. The present invention, however, does not contemplate the elimination of mortgages at all in financing these properties. In fact, the title holder may obtain mortgages to purchase these properties.

It is noted that the present invention contemplates any suitable legal entity other than a corporation to be used as the title holder entity 20. For simplicity, in the claims of the patent application herein, the term “corporation” is used but this term is intended to refer to any legal entity, including a corporation, a limited liability company, etc., that can issue shares of stock or the equivalent as evidence of ownership thereof and that can do so in different “classes” of said stock to different individuals or entities. Instead of the term “corporation”, the term “title holder” is frequently also used.

The title holder then issues shares of stock or their equivalent for the benefit of the applicant in proportion to its actual ownership interest in the property, with the applicant entitled to sole use and enjoyment of the property.

Each applicant and the title holder entity essentially enter into a lease that provides the applicant with an option to buy all or part of the remainder of the home ownership interest. The applicant's shares of stock or other evidence of ownership or other eligible collateral can be held by the title holder or by a third-party as rent security as in any other landlord-tenant relationship. Furthermore, the tenant has a non-forfeitable right to purchase all or part of the remaining ownership interest in the home at any time.

The title holder assigns an account number to each approved applicant and, accordingly, issues a segregated class of common stock or the equivalent for each house subject to the program. Therefore, the creation of a new corporation, or other entity, is not necessary for each house under the program.

The homeownership shares in the common stock of title holder entity 20 that are not owned by the applicant are purchased by a consolidating or pooling company 30. This company assigns small portions of each class of stock or equivalent security to packages, or combinations, of diverse homeownership interests to minimize any risk of loss to the pool due to declines in certain home values or defaults. These equity pools 40a, 40b, 40c, 40d etc. are then made available for sale to mutual funds and the general public 50. Thus, each equity pool (for example 40a) owns a portion of the pooling entity 30 and collectively, the plurality of equity pools 40 owns the pooling entity 30 entirely. Each equity pool 40a, 40b, 40c, 40d, etc. is also owned by a member of the general public 50 and the plurality of equity pools 40 are owned by the general public 50. The term “general public” is intended here to include both the individual members of the general public who would invest as well as other institutional investors such as banks, insurance companies, pension plans and mutual funds.

Various equity pools of homeownership interests will inevitably experience different rates of changes in the underlying ownership structures as homeowners buy or sell shares of their homes. An underwriter will inevitably be invested in fractional pools, but to maintain standard pool sizes various underwriters can pool or trade their fractional interests accordingly. A central clearing company would service this need of participating underwriters while maintaining the stability of the pools of homeownership interests traded publicly.

Advantages to Investors

The method and system of the present invention makes it possible for the investor to realize significant long-term capital gains due to the participation in the ownership of the underlying asset, residential real estate. In addition, assuming most homeowners sell their homes within 5 to 7 years after purchasing them anyway, the present invention allows an owner-occupant to sell its homeownership rights when moving without having to sell the entire home. The investor, therefore, does not incur any transaction costs, such as real estate broker commissions, mortgage recording tax, and legal fees, each time rights to a home participating in the method and system of the present invention are sold.

At the same time, the homeowner pays rent while accumulating the wealth necessary to buy additional shares of his/her home. This rent, less management fees, can be paid out to investors in the form of cash dividends with a yield very competitive with yields on comparable mortgages.

The present invention ultimately is a more efficient approach than that of Fannie Mae (“FNMA”). FNMA is a public company and therefore already employs equity financing to home ownership indirectly. It effectively makes possible the purchase and resale of mortgages while shifting and splitting up the associated investment risks. Simply put, if the present invention requires processing by only one bureaucracy, the underwriter, and a mortgage goes through two or more bureaucracies (e.g. the bank, GNMA, FNMA, etc.), the present invention will be the cheaper way of doing business and provide more value to homeowners and shareholders.

From the Homeowner's Point of View

The underwriter screens applicants, much like banks do for conventional mortgages, except that loan to value ratios are not applicable. For example, if the applicant or a guarantor has sufficient eligible collateral, but doesn't want to convert it cash to purchase the home, the entire purchase price of the home can be equity-financed.

Another example is where the applicant has substantial income, but can afford only a minimal down payment, such as 5%. In that case, the applicant may also apply for conventional financing such that the actual down payment represents at least 20% of the applicant's contemplated ownership interest. Ignoring underwriting fees for the purpose of simplicity, if the applicant wanted to live in a home valued at $100,000, for instance, he/she could pay $5,000 out of pocket and obtain a conventional mortgage of $20,000. The applicant's contemplated ownership interest is then valued at $25,000 with 20%, or $5,000, down. The remaining $75,000 of the home's purchase price is equity-financed and owned indirectly by the public.

Effectively, the present invention in substance is similar to an initial public offering for a corporation. Without the present invention, only businesses get the opportunity to raise funds such that control of the company can be attained with as little as 3% of the company's ownership. Only businesses can control and manipulate their debt-to-equity ratios as business conditions change. Individual homeowners deserve the same opportunities as those afforded by the present invention.

There is also a legal advantage obtained by the homeowner by virtue of not holding title to the property individually. This is beyond the scope of the invention, but a homeowner participating in the program can consider further legal measures to limit his/her general liability for situations such as a third-party's injury occurring at the home.

Currently, tax law permits an individual to deduct from taxable income most of that individual's mortgage interest that was paid and allows an individual under the age of 59½ to take up to ten thousand dollars out of his/her individual retirement account (“IRA”) to purchase his/her first home without having to pay a 10% early distribution penalty. Furthermore, gains of up to five hundred thousand dollars are excludable from income on the sale of a principal residence owned and used as such for at least 2 out of the most recent 5 years. With the recent general increase in home prices and ever increasing numbers of people subject to the alternative minimum tax, which limits the amount of a taxpayer's deductible mortgage interest and real estate taxes, as a matter of public policy, the tax law should give much more favorable tax treatment to an individual's savings toward the purchase of his/her home over time.

Therefore, with changes in the current tax law, the present invention makes it possible for an individual to save for homeownership over time via an IRA. An individual can contribute cash to his/her IRA over time, the IRA can be held by a custodian acceptable to the Internal Revenue Service, and the funds deposited in the IRA can then be used to purchase shares of the title holding company's ownership of the individual's principal residence. An IRA currently cannot be used as collateral, which the present invention contemplates, but an exception should be made for the purpose of ultimate homeownership.

Additional tax advantages are also available for higher-income and -net worth individuals in that certain lost deductions in higher tax brackets can be mitigated by paying rent as opposed to mortgage interest and real estate taxes. Mortgage interest arising from a home acquisition cannot be deducted to the extent the interest accruing relates to home acquisition indebtedness in excess of $1 million. Mortgage interest arising from a home equity loan cannot be deducted to the extent the interest accruing relates to home equity indebtedness in excess of a hundred thousand dollars. Since these amounts are not indexed to inflation, more and more individuals will be subject to these limitations in future years. Furthermore, real estate taxes cannot be deducted in the calculation of alternative minimum taxable income. The present invention is also more tax efficient if adopted as part of a business model incorporating active management of the subject properties to a certain extent. A discussion of the passive activity rules, though, is beyond the scope of this patent application.

When referring herein to “a separate applicant” this means a distinct applicant for the particular property being purchased, it being clear that two or more separate applicants for two different properties can of course at least in theory be the same individual or entity.

Furthermore, although in a preferred embodiment, applicants are individuals or married couples who seek to own their own homes, the present invention contemplates other legal entities as applicants, and other legal entities include corporations, partnerships, limited liability companies, etc. as applicants.

Ownership refers to fee simple ownership or other suitable legal ownership of real property.

A summary of the preferred embodiment of the method of the present invention comprises providing (such as by forming or creating or making available a preexisting company for such use) a title holder entity to take legal title to and hold an equity position in each property of residential real estate participating in the system. The method also includes providing (such as by forming or creating or making an existing company available for such use) a pooling entity to own most of the title holding entity, the pooling entity owned directly or indirectly by the general public. “Most” of the title holding entity means all of the title holding entity except the minority equity portion owned by the owner/occupants.

The one or more underwriters screen applicants from the pool of applicants to determine each applicant's financial suitability to be an owner/occupant. Pursuant to appropriate legal documents calling for such to occur, the title holder entity issues and sells shares of a class of stock in the title holder entity, said class of stock unique to a particular applicant, for each of said residential real estate property, the particular applicant obtains sole use and enjoyment of the property and becomes an owner/occupant of the property, the applicant pays the sale price of the shares of the class of stock representing typically between approximately 1% and approximately 5% of the market value of the property plus underwriting fees, each applicant also pays regular rent to the title holder entity for said use and enjoyment of the property in exchange for additional shares of the class of stock unique to that applicant, and the title holder entity issues cash dividends to the general public in the amount of the rent less management fees.

In the above method, the range of “approximately 1% to approximately 5%” of the market value is merely illustrative and preferred. The sale price could be smaller than 1% and could be significantly larger than 5%.

A summary of the preferred embodiment of the system of the present invention may include an underwriter(s) that forms or makes available the title holder entity and that screens the applicants. The system includes a plurality of applicants from a pool of applicants whose financial suitability to be owner/occupants has been satisfactorily determined, presumably by the underwriter(s). The system also includes a title holder entity that takes legal title to and holds an equity position in each property of residential real estate. The title holder entity issues and sells shares of a class of stock in the title holder entity, said class of stock unique to a particular applicant, for each of said residential real estate property. Legal documents, such as one or more contracts, are entered into between the title holder entity and applicants from the pool of applicants providing that

(i) the title holder entity will issue and sells shares of a class of stock in the title holder entity, said class of stock unique to a particular applicant, for a particular residential real estate property (for example homes H1, H2, etc.)

(ii) a particular applicant is entitled to sole use and enjoyment of the property (e.g. H1),

(iii) the particular applicant will become an owner/occupant of the property (H1),

(iv) the applicant pays a specified sale price for the shares, said share price typically representing between approximately 1% and approximately 5% of the market value of the property plus underwriting fees, and

(v) the title holder entity will issue cash dividends to the general public in an amount of the rent less management fees,

(vi) the particular applicant pays regular rent to the title holder entity for said use and enjoyment of the property in exchange for additional shares of the class of stock unique to that particular applicant, and

(vii) the particular applicant has an option to buy a remainder interest of the residential real estate property.

The system also includes a pooling entity that owns most of the title holding entity. The pooling entity is itself owned directly by the general public or it is owned indirectly by the general public in that it is owned by a collection of equity pools that are owned by the general public. The contract also provides that each particular applicant pays regular rent to the title holder entity for the use and enjoyment of the property in exchange for additional shares of the class of stock unique to that particular applicant.

It is to be understood that while the system and method of the present invention have been described and illustrated in detail, the above-described embodiments are simply illustrative of the principles of the invention. It is to be understood also that various modifications may be devised by those skilled in the art which will embody the principles of the invention and fall within the spirit and scope thereof. It is not desired to limit the invention to the exact construction and operation shown and described. The spirit and scope of this invention are limited only by the spirit and scope of the following claims.

What is claimed is:

1. A method of financing individual residential real estate ownership without significant transaction costs so as to make said financing more affordable and accessible to a pool of applicants, comprising:
providing a title holder entity to take legal title to and hold an equity in each property of residential real estate,
providing a pooling entity to own most of the title holding entity, the pooling entity owned directly or indirectly by a general public,
screening applicants from the pool of applicants to determine each applicant's financial suitability to be an owner/occupant,
causing the title holder entity to issue and sell shares of a class of stock in the title holder entity, said class of stock unique to a particular applicant, for each of said residential real estate property, each sale of shares of the class of stock in the title holder entity entitling the particular applicant to sole use and enjoyment of the property and rendering the applicant an owner/occupant of the property,
a particular applicant paying a sale price of the shares representing between approximately 1% and approximately 5% of a market value of the property plus underwriting fees,
each applicant also paying regular rent to the title holder entity for said use and enjoyment of the property in exchange for additional shares of the class of stock unique to that applicant, and
causing the title holder entity to issue cash dividends to the general public in an amount of the rent less management fees.

2. The method of claim 1, including forming a plurality of equity pools, each of the equity pools in the plurality of equity pools owning a portion of the pooling entity so that the plurality of equity pools collectively owns the pooling entity entirely, each equity pool of said plurality of equity pools being owned by the general public.

3. The method of claim 1, wherein each applicant's shares of stock in the title holder entity or other evidence of said applicant's ownership of stock in the title holder corporation are held by the title holder entity as security for the rent.

4. The method of claim 1, including forming a plurality of equity pools, each of the equity pools in the plurality of equity pools owning a portion of the pooling entity so that the plurality of equity pools collectively owns the pooling entity entirely, each equity pool of said plurality of equity pools being owned by the general public and wherein each applicant's shares of stock in the title holder entity or other evidence of said applicant's ownership of stock in the title holder entity are held by the title holder entity as security for the rent.

5. The method of claim 1, wherein an underwriter forms the title holder entity and screens the applicants from the pool of applicants.

6. The method of claim 1, wherein the shares of the class of stock are shares of common stock in the title holder entity.

7. The method of claim 1, wherein providing a title holder entity means forming a title holder entity and wherein providing a pooling entity means forming a pooling entity.

8. The method of claim 1, wherein the sale price is between approximately 1% and approximately 5% of the market value plus underwriting fees.

9. A method of financing individual residential real estate ownership without significant transaction costs so as to make said financing more affordable and accessible to a pool of applicants, comprising:
providing a title holder entity to take legal title 'to and hold equity in each property of residential real estate,
providing a pooling entity to own most of the title holding entity,
causing members of the general public to own the pooling entity directly or through ownership of another entity,
screening applicants from the pool of applicants to determine each applicant's financial suitability to be an owner/occupant,
the title holder entity and applicants entering into written agreements providing that
(i) the title holder entity will issue and sell shares of a class of stock in the title holder entity, said class of stock unique to a particular applicant, for a particular residential real estate property,
(ii) a particular applicant is entitled to sole use and enjoyment of the property,
(iii) the particular applicant will become an owner/occupant of the property,
(iv) the applicant pays a sale price of the shares, said share price representing between approximately half of 1% and approximately 20% of a market value of the property plus underwriting fees, and
(v) the title holder entity will issue cash dividends to the general public in an amount of the rent less management fees,
(vi) the particular applicant also pays regular rent to the title holder entity for said use and enjoyment of the property in exchange for additional shares of the class of stock unique to that particular applicant, and
(vii) the particular applicant has an option to buy a remainder interest of the residential real estate property.

10. The method of claim 9, including forming a plurality of equity pools, each of the equity pools in the plurality of equity pools owning a portion of the pooling entity so that the plurality of equity pools collectively owns the pooling entity entirely, each equity pool of said plurality of equity pools being owned by the general public.

11. The method of claim 9, wherein each applicant's shares of stock in the title holder entity or other evidence of said applicant's ownership of stock in the title holder corporation are held by the title holder entity as security for the rent.

12. The method of claim 9, including forming a plurality of equity pools, each of the equity pools in the plurality of equity pools owning a portion of the pooling entity so that the plurality of equity pools collectively owns the pooling entity entirely, each equity pool of said plurality of equity pools being owned by the general public and wherein each applicant's shares of stock in the title holder entity or other evidence of said applicant's ownership of stock in the title holder entity are held by the title holder entity as security for the rent.

13. The method of claim 9, wherein an underwriter forms the title holder entity and screens the applicants from the pool of applicants.

14. The method of claim 9, wherein the shares of the class of stock are shares of common stock in the title holder entity.

15. The method of claim 9, wherein providing a title holder entity means forming a title holder entity and wherein providing a pooling entity means forming a pooling entity.

16. The method of claim 9, wherein the sale price is between approximately 1% and approximately 5% of the market value plus underwriting fees.

17. A system for financing individual residential real estate ownership without significant transaction costs, comprising:
a plurality of applicants from a pool of applicants whose financial suitability to be an owner/occupant has been satisfactorily determined;
a title holder entity that takes legal title to and holds an equity position in each property of residential real estate; and
legal documents entered into by the title holder entity and applicants providing that
(i) the title holder entity will issue and sell shares of a class of stock in the title holder entity, said class of stock unique to a particular applicant, for a particular residential real estate property,
(ii) the sale of shares of the class of stock in the title holder entity entitles a particular applicant to sole use and enjoyment of the property,
(iii) the particular applicant will become an owner/occupant of the property,
(iv) the applicant pays a sale price of the shares, said share price representing between approximately half of 1% and approximately 20% of a market value of the property plus underwriting fees, and
(v) the title holder entity will issue cash dividends to the general public in an amount of the rent less management fees,
(vi) the particular applicant pays regular rent to the title holder entity for said use and enjoyment of the property in exchange for additional shares of the class of stock unique to that particular applicant,
(vii) the particular applicant has an option to buy a remainder interest of the residential real estate property; and
a pooling entity that owns most of the title holding entity, the pooling entity owned directly or indirectly by the general public.

18. The system of claim 17, including a plurality of equity pools that collectively own the pooling entity, each equity pool of said plurality of equity pools owning a portion of the pooling entity, and each equity pool of said plurality of equity pools being owned by the general public.

19. The system of claim 17, wherein each applicant's shares of stock in the title holder entity or other evidence of said applicant's ownership of stock in the title holder corporation are held by the title holder entity as security for the rent.

20. The system of claim 17, including a plurality of equity pools that collectively own the pooling entity, each equity pool of said plurality of equity pools owning a portion of the pooling entity, and each equity pool of said plurality of equity pools being owned by the general public and wherein each applicant's shares of stock in the title holder entity or other evidence of said applicant's ownership of stock in the title holder entity are held by the title holder entity as security for the rent.

21. The system of claim 17, including an underwriter that provides the title holder entity and pooling entity and that screens the applicants from the pool of applicants.

22. The system of claim 17, wherein the shares of the class of stock are shares of common stock in the title holder entity.

23. The system of claim 17, wherein the sale price is between approximately 1% and approximately 5% of the market value plus underwriting fees.
